(19) United States
(12) Patent Application Publication
(10) Pub. No.: US 2017/0231256 A1
(43) Pub. Date: Aug. 17, 2017

(54) TEMPERATURE-RESISTANT FORMULATION CONTAINING NATURAL COLORING AGENT FOR FOOD

(71) Applicant: Deutsches Institut Fuer Lebensmitteltechnik E.V., Quakenbrueck (DE)

(72) Inventors: Ute Bindrich, Quakenbrueck (DE); Dieter Albers, Bad Rothenfelde (DE)

(21) Appl. No.: 15/502,422

(22) PCT Filed: Jul. 17, 2015
(86) PCT No.: PCT/EP2015/066431

§ 371 Date: Feb. 7, 2017

(30) Foreign Application Priority Data
Aug. 8, 2014 (EP) 14180407.0
Apr. 14, 2015 (EP) 15163598.4

(51) Int. Cl. A23L 5/43; A23L 29/10; C09B 61/00

(52) U.S. Cl. CPC A23L 5/43; C09B 61/00; A23L 29/10; A23V 2002/00

(57) ABSTRACT

The invention relates to a temperature stable formulation having a water soluble natural coloring agent, which formulation is a water-in-oil emulsion, in which the coloring agent is contained in the aqueous phase and is stable at an increased temperature, e.g. at at least 72° C. The coloring agent can be thermally instable at the pH of the food, into which the formulation was mixed.

The invention relates to a temperature stable formulation with a natural coloring agent for use as a dye for food, the formulation containing at least one hydrophilic coloring agent in an aqueous phase, as well as food containing the formulation. The coloring agent can be suspensible or soluble in the aqueous phase and preferably is a natural coloring agent, e.g. a plant extract, extract from beetroot, betanin, extract of green plants, e.g. extract from parsley, chlorophyll, or sepia from squid. Further, the invention relates to a process for the production of the formulation and process for the production of food which contain the formulation.

The formulation has the advantage that therein heat sensitive coloring agents are resistant against higher temperatures in food which have a pH value at which the coloring agent outside of the formulation at higher temperature disintegrates. For example, the coloring agent composition attains the stability of betanin in sausage meat against temperatures of 72° C., as they occur at pasteurization.

### STATE OF THE ART

EP 1 972 206 B1 describes a coloring agent composition which is an oil-in-water emulsion, in which the oil phase is formed of a fat-soluble carotinoid dye and as emulsifiers contains 45-55 wt.-% lecithin and 55-45 wt.-% of a saccharose-fatty acidester. The coloring agent composition shall have a high acid resistance and be suitable for fruit compositions, fruity-flavored milk product without egg or fruity sweets.

EP 1 180 332 B1 describes the addition of the beetroot coloring agent betanin as a thermally instable coloring agent to a protein-containing food which is free from animal compounds, which coloring agent is destroyed by warming up to ca. 50° C., as well as the addition of a reducing sugar for a thermal browning reaction.

GB 669,363 describes the production of a green coating mass of brilliant blue dissolved in water and tartrazine, to which lecithin was added, and subsequently firstly coconut oil and then icing sugar, milk powder and citric acid are admixed.

### OBJECT OF THE INVENTION

The object of the invention is to provide a composition and a process for its production, in which natural temperature-sensitive coloring agents are stable against increased temperatures, especially in a food having a pH value at which the coloring agent is instable at increased temperature.

### DESCRIPTION OF THE INVENTION

The invention achieves the object by the features of the claims, especially by a temperature-stable formulation with a coloring agent, which formulation is a water-in-oil-emulsion, in which the coloring agent is contained in the aqueous phase and is stable at increased temperature, e.g. above 50° C., preferably above 60° C. or above 70° C., more preferred at at least 72° C., especially at a pasteurizing temperature for 10 to 180 min, e.g. for 15 to 40 min or up to 25 min.

The coloring agent preferably is one which is thermally instable at the pH of the food, into which the formulation is admixed. The coloring agent is especially water soluble and preferably is a natural coloring agent, e.g. coloring agent from beetroot, especially E476, or green plant extract, e.g. parsley extract.

The formulation is characterized in that the coloring agent contained therein is stable against increased temperatures, especially when the formulation is contained in a food, at the pH value of which the coloring agent outside of the formulation is thermally instable. Therefore, the invention also relates to food which contain the formulation and which have been brought to an increased temperature, e.g. are pasteurized. For the beetroot coloring agent betanin as coloring agent, preferred foods especially are meat products and sausage products, especially cooked sausage. For green plant coloring agents, especially chlorophyll, e.g. extract from green plants, especially from parsley, preferred foods are such having a pH value below 7, e.g. having a pH of from 7 to 8, e.g. food on the basis of or from plant constituents, which can be acidified, e.g. fruit and vegetable preparations, e.g. on the basis of or from avocado, cucumber and/or paprika. The natural coloring agent of beetroot, as a powder or extract of beetroot, respectively betanin, is instable at higher temperatures, especially in food which have a pH value above 5.5, like e.g. meat products and sausage products.

Green plant extracts as a natural coloring agent have the disadvantage to be instable against higher temperatures in an acidic environment.

The aqueous phase of the formulation has a pH value at which the coloring agent is stable against increased temperatures. It was found that this aqueous phase is stable within the oil phase and a temperature treatment of a food, in which this formulation is contained, essentially does not disintegrate the coloring agent, especially maintains it without or with small color deterioration even when the food has a pH value at which the coloring agent is instable at the increased temperature.

Therein, increased temperatures preferably are such temperatures at which foods are pasteurized, e.g. 65 to 72° C., especially for 10 to 180 min.

For sausage products and meat products, e.g. for cooked sausage, the formulation according to the invention has the advantage that the color allows for a lower content of nitrate and/or nitrite, because a color stabilization by nitrate and/or nitrite is not necessary, but the pale color caused by increased temperatures is replaced or equalized by the formulation. In this way, in meat products and/or sausage products having a content of the formulation, the content or addition of nitrate and/or nitrite can be reduced by 40 to 50%. Upon production of meat products and/or sausage products, to which the formulation is added, therefore the added amount of nitrate/nitrite, e.g. in the form of nitrite curing salt can be reduced by 40 to 50%, wherein preferably table salt is added in an amount that equalizes the reduced amount of nitrite curing salt, e.g. table salt in an amount corresponding to 60 to 50% of the amount of the nitrite curing salt.

The formulation is also characterized in that in the oil phase the droplets of the aqueous phase have a mean diameter of at maximum 2 μm, preferably at maximum 1.5 μm, more preferred at maximum 1 μm, even more preferred at maximum 0.8 μm, especially having a small breadth of the size distribution, preferably having a size distribution of X₉₀ to X₁₀ of at maximum 20 μm, more preferred of at maximum 15 μm, even more preferred of at maximum 10 μm. This size distribution has the advantage of allowing an even color upon distribution within the food. For meat products and sausage products, this size distribution has the advantage that the formulation can be added to a meat mass during mincing, because the coloring agent formulation remains essentially stable during mincing. At present this is attributed to the small size of the droplets of the aqueous phase of the formulation avoids a mechanical destruction of the droplets.

Accordingly, in the production of meat products and sausage products, the coloring agent formulation is preferably added to the meat mass during mincing for being distributed in the meat mass during mincing.

An advantage of the formulation is that its addition in the production of meat products and sausage products allows a reduced addition of curing salt which contains nitrite and/or nitrate and herein is also designated as nitrite curing salt. This is, because the formulation can at least in part replace the color generated by reddening by means of nitrite curing salt in meat products and sausage products. In general therefore, in the production of meat products and sausage products the addition of nitrite curing salt can be reduced by 40 to 50% by adding the formulation, e.g. for nitrite curing salt containing 0.5 wt.-% sodium nitrite, from approximately 1.6 to 2.0 wt.-%, especially from 1.8 wt.-%, to a content in the range of 0.8 or 0.96 wt.-% to 1.0 or to 1.2 wt.-%, each in relation to the total mass. In this way, e.g. the content of nitrite/nitrate of meat products and sausage products containing the formulation can be reduced by 40 to 50%, e.g. to approximately 40 to 60 mg/kg meat products and sausage products.

The formulation is a water-in-oil-emulsion, which contains or consists of
in a continuous oil phase, a distributed aqueous phase with or of hydrophilic coloring agent distributed or dissolved in water, wherein the aqueous phase has a pH value at which the coloring agent is essentially stable against higher temperatures, wherein
the oil phase, which plant and/or animal fat and at least one emulsifier, preferably 2 to 8 wt.-%, more preferred to 4 to 5 wt.-% of the oil phase,
   wherein optionally salts are contained in the aqueous phase and/or optionally thickening agents are contained in the aqueous phase, especially when the food is fat-reduced.

The ratio from water to oil is e.g. 10:90 to 50:50, preferably 30:70, wt:wt.

The hydrophilic coloring agent, which preferably is a natural coloring agent, at the pH value of the food, into which the formulation has been introduced, is instable against higher temperatures, e.g. disintegrates at pasteurization.

The following pH values of the aqueous phase are preferred:

for the coloring agent betanin pH at maximum 5.5, preferably at maximum 4.5, e.g. 3 to 4, for green plant extract (chlorophyll) as coloring agent pH at minimum, 7.5, preferably 7.5 to 8.5, preferably pH 8.

The fats of the oil phase are liquid at the processing temperatures and storage temperatures of the food, especially at temperatures of 0 to 75° C., preferably at 5 or 8° C., in the absence of emulsifier, preferably in the presence of emulsifier. The fats can e.g. be selected from the group comprising sunflower oil, rape seed oil, soya oil and mixtures thereof. The continuous liquid oil phase can contain a dispersed solid phase, e.g. fatty chrystals and/or organogels.

The emulsifier preferably has an HLB-value (hydrophilic-lipophilic balance value) of at maximum 6, more preferred of at maximum 5. The emulsifier by itself or in mixture with the fats of the oil phase does not crystallize at room temperature. The emulsifier can e.g. be selected from the group comprising or consisting of phospholipids, mono- and diglycerides of food fatty acids, citric acid esters of food fatty acids, polyglycerol ester, preferably polyglycerol-polyricine oleate, and mixtures of at least two of these. A formulation preferably in the oil phase contains 0.1 to 0.5, preferably 0.3 wt.-% lysophosphatidyl cholin, 1 to 4, preferably 1.85 wt.-% phosphatidyl cholin, 0.5 to 2, preferably 1.0 wt.-% phosphatidyl ethanol amine, 0.1 to 0.5, preferably 0.3 wt.-% phospho inositole, and 0.5 to 5 preferably 2.5 wt.-% citric acid esters of food fatty acids (CITREM), or the emulsifier consists thereof. The citric acid esters of food fatty acids are such which are liquid at the temperature of the oil into which they are admixed, especially at room temperature.

It is shown that a content of ionic salts in the aqueous phase can increase the stability of chlorophyll. Therefore, for green plant extracts having a content of chlorophyll a salt content is preferred, which corresponds to an ion concentration of 0.1 to 1.5 wt.-% NaCl. The ionic salt can be selected from KCl, MgCl₂, preferred NaCl, and mixtures of at least two of these.

The thickening agent can e.g. comprise or consist of milk protein, gelatin, carob seed flour, carrageen, agar-agar, pectin and mixtures of these.

In meat products and sausage products, the formulation can be contained in a fraction of 5 to 7, preferably 5.5 to 6.9 wt.-% having a water-oil ratio of 10:90 wt:wt at 8 wt.-% emuslifier.

The production process for the coloring agent composition can comprise or consist of the following steps:
dissolving the coloring agent in water,
adjusting the pH value of the water to a value at which the coloring agent is essentially stable against increased temperatures, for production of the aqueous phase,
mixing the fat of the oil phase with the at least one emulsifier for the production of the oil phase,
temperature adjusting the aqueous phase and the oil phase each to the same temperature, e.g. in the range from 20 to 60° C., preferably in the range from 20 to 45° C.,
prior to or after temperature adjusting, bringing together the aqueous phase and the oil phase and producing a pre-emulsion having a mean droplet size of the aqueous phase in the oil phase of 2 to 30 μm, e.g. by shearing by means of a rotor rotating in a stator,
finely dispersing the pre-emulsion for producing the emulsion having a size distribution of the droplets of the aqueous phase having a mean diameter of at maximum 2 μm, preferably at maximum 1.5 μm, more preferably at maximum 1 μm, even more preferred at maximum 0.8 μm, especially having a small breadth of the size distribution in the oil phase, preferably having a size distribution of X₉₀ to X₁₀ of at maximum 20 μm, preferably of at maximum 15 μm, even more preferably of at maximum 10 μm, e.g. by means of shearing by means of a rotor rotating on a stator, or by means of high pressure homogenization.

The ratio of aqueous phase to oil phase can e.g. be 10:90 to 50:50 wt:wt, e.g. 10:90, 20:80 to 30:70, e.g. 50:50.

The finely dispersing can e.g. occur by means of an Ultra-Turrax as a rotor rotating on a stator, e.g. at 22000 rpm for 2 min, or by means of high pressure homogenization, e.g. in two stages at 80 to 200/50 bar, or by means of a colloid mill, e.g. at 500 to 3000/min.

The emulsion which forms the coloring agent composition is stable against aggregation and stable against coalescence, e.g. for a storage duration of at least 10 d or at least 20 d, more preferred 6 months, at storage in the dark at room temperature, preferably at 0 to 10° C., more preferred at 5 to 7° C.

This process generates a size distribution of the droplets of the aqueous phase in the oil phase. An advantage of the production process and of the size distribution of the aqueous droplets is that thereby a microbiological stability is achieved, so that the formulation can be free from preservative agents and not be preserved by physical processes, e.g. not treated by irradiation, heating, electrical fields or high pressure.

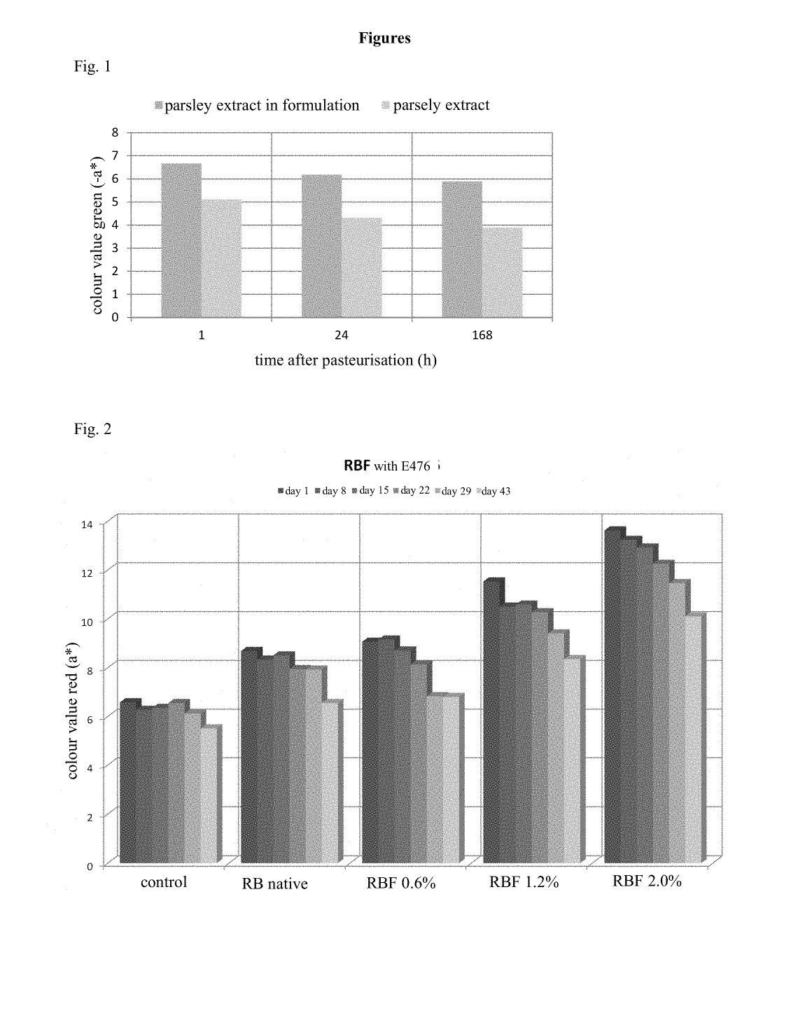

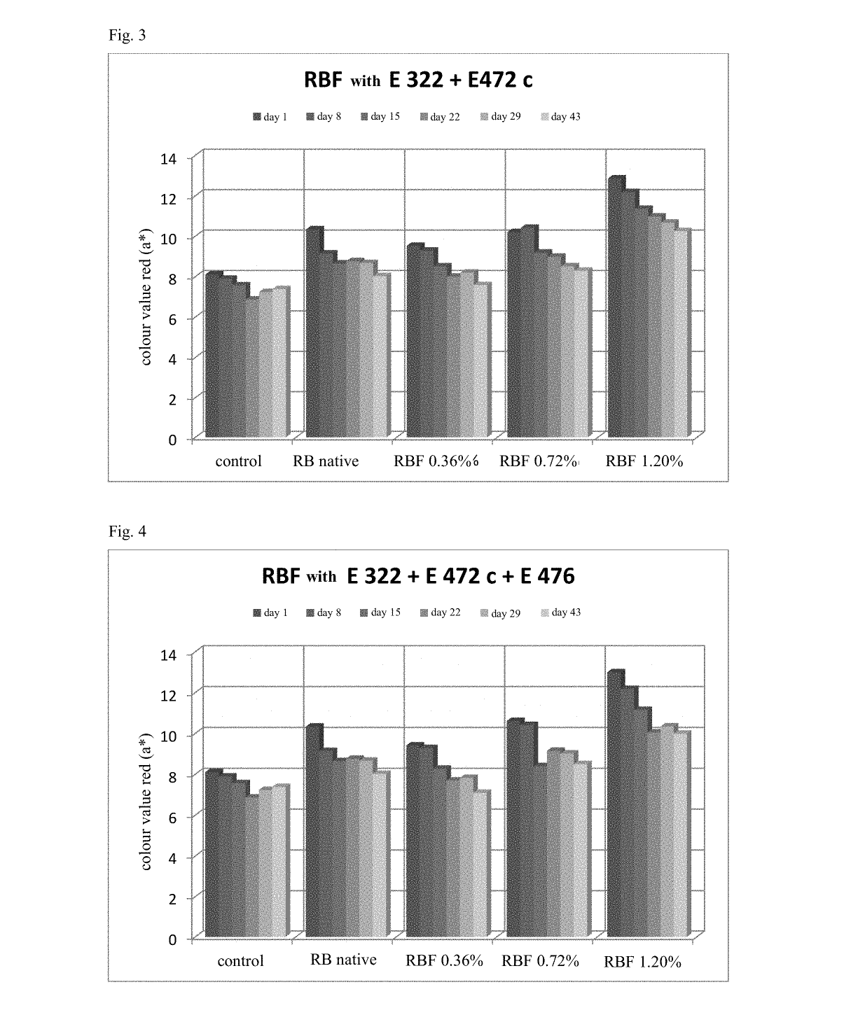

The invention will now be explained by means of examples with reference to the figures, which show in
FIG. 1 the color values green (−a*) measured for compositions with parsley extract in a formulation according to the invention after pasteurization, and
FIG. 2 the color values (a*) measured for cooked sausage with beetroot powder in formulation according to the invention, and
FIG. 3 the color values (a*) measured for cooked sausage with beetroot powder in formulation according to the invention, and
FIG. 4 the color values (a*) measured for cooked sausage with beetroot powder in formulation according to the invention.

### EXAMPLE 1: SANDWICH SPREAD ON THE BASIS OF AVOCADO

The fruit flesh of avocado upon contact with air is subject to browning which can be reduced by addition of acid. As coloring agent a green plant extract, e.g. from parsley, shall be added, which at acidic pH values is not stable against higher temperatures as they occur upon pasteurization.

Green parsley extract is suspended to 10 wt.-% in 100 g water. Preferably the water has a content of 1 wt.-% NaCl. The pH value is adjusted to 8.0, e.g. by addition of thinned aqueous caustic soda. This aqueous phase is united with a solution of 4 wt.-% polyglycerol-polyricinoleate in sunflower oil in a ratio of 30:70 wt.:wt., each temperature adjusted to 30° C., and is dispersed by means of shearing dispersion by a rotor-stator system at 250 to 800 rpm to a pre-emulsion. This pre-emulsion subsequently is dispersed by means of a high pressure homogenizer in two stages (200 bar/50 bar) to the emulsion, which forms the formulation. The droplets of the aqueous phase in the formulation had a mean size (d_{2,3}) of 0.6 μm.

87.75 wt.-% avocado purée,

3.0 wt.-% lemon juice,

1.5 wt.-% onion in granular form,

0.75 wt.-% garlic in granular form,

1.0 wt.-% table salt,

0.5 wt.-% ground pepper,

0.5 wt.-% carob seed flour, and

5.0 wt.-% formulation

were homogeneously mixed in order to prepare a first composition, and filed into glasses.

The glasses were closed with lids and warmed for 10 min to 72° C. for pasteurization.

As a second composition

89.4 wt.-% avocado purée,

3.2 wt.-% lemon juice,

0.8 wt.-% onion in granular form,

0.5 wt.-% garlic in granular form,

0.55 wt.-% table salt,

0.3 wt.-% ground pepper,

0.25 wt.-% carob seed flour, and

5.0 wt.-% formulation

were homogenously mixed and warmed for 10 min to 72° C. for pasteurization.

For a comparative mixture, the same ingredients, but instead of the formulation with parsley extract, were adjusted to pH 8, admixed with 1 wt.-% NaCl and pasteurized immediately. The amount of parsley extract was the same in the first and second compositions as well as in the comparative mixture.

The color values for green (−a*), represented in FIG. 1, show that the formulation according to the invention, respectively the color by the formulation, essentially is stable at pasteurization, even if the contained coloring agent chlorophyll at the acidic pH of the mixture would lose its color at pasteurization, as it is observed for the comparative mixture. In FIG. 1, the respective left column shows the second formulation, the right column the comparative mixture, each after 1 h, 24 h, 168 h storage at 4° C. following pasteurization.

### EXAMPLE 2: COOKED SAUSAGE

Beetroot powder was suspended at 60° C. to 56 wt.-% in water. Optionally, 0.5 wt.-% pectin (CM 203) is added as a thickening agent. The pH value is adjusted to 4.4 to produce the aqueous phase. As emulsifier, polyglycerol-polyricinoleate (E467) is dissolved to 4 wt.-% in sunflower oil to produce the oil phase. The aqueous phase and the oil phase were temperature adjusted to 45° C. and united in a 70:30 weight ratio, then dispersed by means of a rotor-stator system at 500 to 800 rpm to a pre-emulsion. The pre-emulsion is dispersed by a high pressure homogenizer in two stages 200 bar/50 bar to the emulsion, which forms the formulation. The droplets of the aqueous phase had a mean size (d_{2,3}) of 0.6 μm in the continuous oil phase.

For producing sausage meat, this formulation was admixed during mincing to 0.6, 1.2, or 2 wt.-% in relation to the total mass, to a sausage meat of

40 wt.-% pork meat S III,

20 wt.-% belly of pork S V,

10 wt.-% cheek of pork S VI,

10 wt.-% neck fat of pork S VII,

20 wt.-% filling (water ice) and,

each in relation to the total mass, as ingredients 1.8 wt.-% nitrite curing salt, 0.3 wt.-% sodium diphosphate, 0.05 wt.-% sodium ascorbate. The nitrite curing salt contained 0.5 wt.- % sodium nitrite.

The minced sausage meat was filled into sausage casing and heated at a chamber temperature of 80° C. to a core temperature of 72° C.

The measured color values for red (a*), represented in FIG. 2, show that the coloring agent formulation according to the invention at a treatment at higher temperature is stable, even if the coloring agent contained at the pH of approximately 5.8 of the mixture would lose its color upon heating. In FIG. 2 the columns for each concentration of the beetroot formulation (RBF) from left to right show the color value subsequent to heating each on day 1, day 8, day 15, day 22, day 29, and day 43 of the subsequent storage at 4° C. For comparison, the same sausage mass, but without coloring agent (control) and with 0.1 wt.-% beetroot powder respectively, optionally in water (RB native) was treated in parallel, wherein this concentration is equal to the concentration of the beetroot powder in 0.6 wt.-% of the

formulation. The undyed sausage meat had a very low red color, the sausage meat with beetroot powder (RB native) a small red color, which reduced with increasing storage duration, while sausage meat with beetroot formulation according to the invention (RBF 0.6%, RBF 1.2% and RBF 2.0%) showed a more intensive red color, which also during the storage duration still had a sufficient intensity. It showed in detail that the color was also present in the fringe areas of the sausage. This shows the suitability of the formulation also for the production of foods, which are treated by an increased temperature, as the fringe areas of the sausage during the heating were exposed to the chamber temperature, which lay above the core temperature attained.

In an alternative composition, the above mentioned sausage mass with the same composition, but with a proportion of nitrite curing salt reduced by 40 to 50% (1.08 to 0.9 wt.-% nitrite curing salt (0.5 wt.-% sodium nitrite), in relation to the total mass) was produced. The lacking amount of salt was equalized by addition of 0.4 to 0.5 wt.-% table salt (sodium chloride).

In a further alternative composition, the above mentioned sausage mass with 1.8 wt.-% nitrite curing salt or having a content of nitrite curing salt reduced by 40 to 50% and addition of table salt to a total of 1.8 wt.-% nitrite curing salt and table salt was mixed, but with replacing the meat constituents by such having a smaller amount of muscle meat. In this sausage meat, the addition of the formulation could equalize the pale color of meat constituents, so that the sausage meat had a pleasant pink to red color.

This example also shows that an appealing color of the sausage is obtained using the formulation at a lower proportion of muscle meat and/or at a lower content of nitrite curing salt.

### EXAMPLE 3: COOKED SAUSAGE

A sausage filing having the same composition as in example 2 was admixed with 0.36 wt.-%, 0.72 wt.-%, or 1.20 wt.-% of a formulation according to the invention as a coloring agent, which formulation was produced by
dissolving 56 wt.-% beetroot powder in water at 60° C.,
adjusting the pH to 4.4 for producing the aqueous phase,
mixing of sunflower oil with 0.3 wt.-% lysophosphatidyl cholin, 1.85 wt.-% phosphatidyl cholin, 1.0 wt.-%. phosphatidyl ethanol amine, 0.3 wt.-% phospho inositol (in summary designated as E322) and 2.5 wt.-% citric acid esters of food fatty acids (E472c),
temperature adjusting of the aqueous phase with the oil phase to 45° C. and mixing in a weight ratio aqueous phase:oil phase of 70:30,
   dispersing to a pre-emulsion by means of a rotor stator system at 500 to 800 rpm with subsequent finely dispersing with an Ultra-Turrax at 22000 rpm for 2 min, with a high pressure homogenizer in two stages at 80 to 200 bar/50 bar, and/or a colloid mill at 500 to 3000/min.

The minced sausage meat mixed with the formulation was filled into sausage casing and heated at a chamber temperature of 80° C. to a core temperature of 72° C., subsequently allowed to cool, cut into slices, packed airtight in foil, and stored at 4° C.

The cooked sausage showed a sufficiently strong and stable color, which was more intensive and more stable than the undyed sausage meat (control) produced as a comparison, or than sausage meat with native beetroot powder in water (RB native). The measured color values a* are shown in FIG. 3 for the added concentration of beetroot formulation (RBF), wherein the columns from left to right show the color value after the heating each on day 1, day 8, day 15, day 22, day 29, and day 43 of the subsequent storage at 4° C. The control was sausage meat without coloring agent addition, RB native was beetroot powder, optionally in water, at 0.1 wt.-%, wherein this concentration is equal to the concentration of the beetroot powder in 0.36 wt.-% of the formulation. The results show that the formulation results in a more stable color for the storage duration.

### EXAMPLE 4: COOKED SAUSAGE

A sausage meat of the same composition as an example 2 was admixed with 0.36 wt.-%, 0.72 wt.-%, or 1.20 wt.-% of a formulation according to the invention as coloring agent, which was produced by
dissolving 56 wt.-% beetroot powder in water at 60° C.,
adjusting the pH to 4.4 for producing the aqueous phase,
mixing of sunflower oil with 0.3 wt.-% lysophosphatidyl cholin, 1.85 wt.-% phosphatidyl cholin, 1.0 wt.-%. phosphatidyl ethanol amine, 0.3 wt.-% phospho inositole (in summary designated as E322), 0.7 wt.-% polyglycerol-polyricinoleate (E476) and 2.5 wt.-% citric acid esters of food fatty acids (E472c),
temperature adjusting of the aqueous phase with the oil phase to 45° C. and mixing in a weight ratio aqueous phase: oil phase of 70:30,
   dispersing to a pre-emulsion by means of a rotor stator system at 500 to 800 rpm with subsequent finely dispersing with an Ultra-Turrax at 22000 rpm for 2 min, with a high pressure homogenizer in two stages at 80 to 200 bar/50 bar, and/or a colloid mill at 500 to 3000/min.

The sausage meat mixed with the formulation and minced, was filled into sausage casings and was heated at a chamber temperature of 80° C. to a core temperature of 72° C., subsequently allowed to cool, cut into slices, packed airtight in foil, and stored at 4° C.

This cooked sausage had a sufficiently strong and stable color, which was more intensive and more stable than the undyed sausage meat (control) produced as a comparison, or than sausage meat with native beetroot powder in water (RB native). The measured color values a* are shown in FIG. 4 for the added concentrations of beetroot formulation (RBF), wherein the columns from left to right show the color value subsequent to heating on day 1, day 8, day 15, day 22, day 29, and day 43 each of the subsequent storage at 4° C. The control was sausage meat without coloring agent addition, RB native was the beetroot powder, optionally in water, at 0.1 wt.-%, wherein this concentration is equal to the concentration of the beetroot powder in 0.36 wt.-% of the formulation. These results show that the formulation results in a color more stable over the storage duration.

1. Temperature-stable formulation for a food, the formulation being a water-in-oil emulsion, in the aqueous phase of which a hydrophilic coloring agent is contained, with an emulsifier in the continuous oil phase, wherein the coloring agent at the pH value of the food is instable at an increased temperature, wherein the aqueous phase is adjusted to a pH value at which the coloring agent is stable at the increased temperature,. and the aqueous phase has a mean droplet size of at maximum 1.5 μm in the oil phase.

2. Formulation according to claim 1, wherein the coloring agent contains betanin and the aqueous phase has a pH value equal to or lower than 5.5.

3. Formulation according to that it is contained in a claim 1, wherein the food is a meat product or sausage product, including an addition of nitrite curing salt reduced by 40 to 50%.

4. Formulation according to claim 1, wherein the coloring agent contains chlorophyll and the aqueous phase has a pH value of 7.5 to 8.5.

5. Formulation according to claim 4, wherein the salt content of the aqueous phase is adjusted to an ionic concentration corresponding to 0.1 to 1.5 wt.-% NaCl.

6. Formulation according to claim 1, wherein the emulsifier is selected from the group consisting of polyglycerol-polyricinoleate, polyglycerol ester, phospolipids, mono- and diglycerides of food fatty acids, citric acid esters of food fatty acids, a mixture with or consisting of lysophosphatidyl cholin, phosphatidyl cholin, phosphatidyl ethanol amine, phospho inositole and citric acid esters of food fatty acids (CITREM), and mixtures thereof

7. Formulation according to claim 1, wherein the aqueous phase is free from an auxiliary solvent.

8. Formulation according to claim 1, wherein the aqueous phase contains a thickening agent which is selected from the group consisting of milk protein, gelatin, carob seed flour, carrageen, agar-agar, pectin, and mixtures thereof.

9. Process for the production of a temperature stable formulation for food, the process comprising steps of:
dissolving coloring agent in water,
adjusting the pH value of the water to a value at which the coloring agent essentially is stable against increased temperatures, for production of the aqueous phase,
mixing of fat of the oil phase with the at least one emulsifier for producing the oil phase,
temperature adjusting of the aqueous phase and of the oil phase each to the same temperature,
prior to or subsequent to the temperature adjusting, bringing together the aqueous phase and the oil phase and producing a pre-emulsion having a mean droplet size of the aqueous phase in the oil phase of 2 to 30 μm,
finely dispersing the pre-emulsion for producing the emulsion having a size distribution of the droplets in the aqueous phase with a mean diameter of at maximum 2 μm.

10. Process according to claim 9, wherein the coloring agent has betanin and the pH value of the water is adjusted to 3 to 5.5.

11. Process according to claim 9, wherein the coloring agent has chlorophyll and the pH value of the water is adjusted to 7.5 to 8.5.

12. Process according to claim 9, wherein the emulsion as a formulation of the coloring agent is mixed with a food and subsequently heated to a temperature of at least 60° C., wherein the food has a pH value at which the coloring agent outside the formulation at least at this temperature disintegrates.

13. Process according to claim 9, applied to production of meat products and sausage products, further comprising adding the formulation to a minced meat mass, to obtain a sausage meat, and that the sausage meat is subsequently heated to a temperature of at least 60° C.

14. Process according to claim 13, wherein the meat mass is admixed with an addition of curing salt reduced by at least 40%.

15. Process according to claim 13, wherein nitrite corresponding to at maximum 0.8 to 1.2 wt.-% curing salt with 0.5 wt.-% sodium nitrite, in relation to the total mass, is added to the meat mass.

16. Food, including a formulation according to claim 1, wherein the food has been heated to a temperature of at least 72° C.
